(19) United States
(12) Patent Application Publication
(10) Pub. No.: US 2026/0010657 A1
(43) Pub. Date: Jan. 8, 2026

(54) INFORMATION PROCESSING APPARATUS, SELECTION METHOD, AND NON-TRANSITORY COMPUTER-READABLE STORAGE MEDIUM

(71) Applicant: NEC Corporation, Tokyo (JP)

(72) Inventors: Yuto MATSUNAGA, Tokyo (JP); Kazuya Kakizaki, Tokyo (JP); Ryo Furukawa, Tokyo (JP); Toshinori Araki, Tokyo (JP); Masaya Fujiwaka, Tokyo (JP); Junichi Funada, Tokyo (JP); Jianquan Liu, Tokyo (JP)

(73) Assignee: NEC Corporation, Tolyo (JP)

(21) Appl. No.: 19/245,787

(22) Filed: Jun. 23, 2025

(30) Foreign Application Priority Data
Jul. 4, 2024 (JP) 2024-108426

(51) Int. Cl. G06F 21/64; G06F 40/30; G06Q 10/10

(52) U.S. Cl. CPC G06F 21/64; G06F 40/30; G06Q 10/10

(57) ABSTRACT

An information processing apparatus includes an acquisition unit for acquiring verification information for verifying authenticity of an assertion detail of content, and a selection unit for determining whether the acquired verification information is used for verifying the authenticity of the assertion detail of the content based on the assertion detail extracted from the content. According to this information processing apparatus, it is also possible to make an appropriate decision based on a result of appropriate authenticity determination of the assertion detail of the content.

### INCORPORATION BY REFERENCE

This application is based upon and claims the benefit of priority from Japanese patent application No. 2024-108426, filed on Jul. 4, 2024, the disclosure of which is incorporated herein in its entirety by reference.

### TECHNICAL FIELD

The present disclosure relates to an information processing apparatus, a selection method, and a selection program.

### BACKGROUND ART

Various types of content such as news articles are published daily. The published available content may include content against the facts such as fake news. An example of a technique as a countermeasure against such content is Patent Literature 1. The news distribution system described in Patent Literature 1 requests a predetermined expert to perform a fact check on a news article. Then, in this news distribution system, when results of the fact check are positive evaluations, fairness scores of the news articles are increased. Accordingly, users can determine whether the news articles are likely to be reliable with reference to the fairness scores.

Patent Literature 1: Japanese Unexamined Patent Publication No. 2024-15904

### SUMMARY

Since it entails time, effort, and cost to perform fact check by experts, it is desirable to automate the fact checks, in other words, authenticity determination of assertion details of content. Further, if verification information for authenticity determination of the assertion details of the content is automatically acquired using a method such as search, the authenticity determination can be completely automated.

However, when the verification information is automatically acquired, the acquired verification information may include information that has low relevance to the assertion details of the content and information that has no relevance in some cases. When information that has low relevance to the assertion detail of the content or information that has no relevance to the assertion detail of the content is used as verification information, there is a possibility of accuracy of determination of authenticity being lowered.

The present disclosure has been made in view of the above problems, and an example object of the present disclosure is to provide a technique capable of avoiding a decrease in accuracy of determination of authenticity of an assertion detail of content.

According to an example aspect of the present disclosure, an information processing apparatus includes an acquisition means for acquiring verification information for verifying authenticity of an assertion detail of content, and a selection means for determining whether the acquired verification information is used for verifying the authenticity of the assertion detail of the content based on the assertion detail extracted from the content.

According to an example aspect of the present disclosure, a selection method causes at least one processor to execute an acquisition process of acquiring verification information for verifying authenticity of an assertion detail of content, and a selection process of determining whether the acquired verification information is used for verifying authenticity of the assertion detail of the content based on the assertion detail extracted from the content.

According to an example aspect of the present disclosure, a selection program causes a computer to function as an acquisition means for acquiring verification information for verifying authenticity of an assertion detail of content, and a selection means for determining whether the acquired verification information is used for verifying the authenticity of the assertion detail of the content based on the assertion detail extracted from the content.

According to an illustrative aspect of the present disclosure, there is an illustrative advantage that it is possible to provide a technique capable of avoiding a decrease in accuracy of determination of authenticity of an assertion detail of content.

### BRIEF DESCRIPTION OF DRAWINGS

FIG. 1 is a block diagram illustrating a configuration of an information processing apparatus according to the present disclosure;

FIG. 2 is a flowchart illustrating a flow of a selection method according to the present disclosure;

FIG. 3 is a block diagram illustrating a configuration of another information processing apparatus according to the present disclosure;

FIG. 4 is a diagram illustrating an example of authenticity determination using an LLM;

FIG. 5 is a diagram illustrating an example of selection based on detail of feedback for verification information;

FIG. 6 is a flowchart illustrating an example of a process performed by the information processing apparatus illustrated in FIG. 3;

FIG. 7 is a flowchart illustrating another example of a process of S16 in FIG. 6;

FIG. 8 is a flowchart illustrating still another example of the process of S16 in FIG. 6;

FIG. 9 is a block diagram illustrating a configuration of an information processing apparatus according to a reference example;

FIG. 10 is a block diagram illustrating a configuration of an information processing apparatus according to another reference example; and

FIG. 11 is a block diagram illustrating a configuration of a computer that functions as an information processing apparatus according to the present disclosure.

### EXAMPLE EMBODIMENT

Hereinafter, example embodiments of the present disclosure will be described. However, the present disclosure is not limited to the example embodiments to be described below, and various modifications can be made within the scope described in the claims. For example, example embodiments obtained by appropriately combining techniques (some or all of things or methods) adopted in the following example embodiments can also be included in the scope of the present disclosure. Example embodiments obtained by appropriately omitting some of the techniques adopted in the following example embodiments can also be included in the scope of the present disclosure. Advantages mentioned in the following example embodiments are examples of advantages expected in the example embodiments, and do not define extensions of the present disclosure. That is, example embodiments that do not achieve the advantages mentioned in the following example embodiments can also be included in the scope of the present disclosure.

### First Example Embodiment

A first example embodiment that is an example embodiment of the present disclosure will be described in detail with reference to the drawings. The present example embodiment is a basic form of each example embodiment to be described below. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in the drawings referred to for describing the present example embodiment can also be employed in the other example embodiments included in the present disclosure within a range in which no particular technical problem occurs.

### Configuration of Information Processing Apparatus

A configuration of an information processing apparatus 1 will be described with reference to FIG. 1. FIG. 1 is a block diagram illustrating a configuration of the information processing apparatus 1. As illustrated in FIG. 1, the information processing apparatus 1 includes an acquisition unit 101 and a selection unit 102.

The acquisition unit 101 acquires verification information for verifying authenticity of an assertion detail of content. The content of which authenticity is to be verified may be any content. For example, a news article on the Internet, a message posted on a social networking service (SNS), a message received with an electronic mail, or the like may be the content of which authenticity is to be verified.

The verification information may be information that can be used for authenticity determination of content. A data format of the verification information is not particularly limited. Multi-modal data including data with a plurality of data formats may be used as the verification information. For example, as described in a second example embodiment to be described below, the acquisition unit 101 may search for a web page related to the assertion detail of the content, and acquire a web page detected through the search as the verification information.

The selection unit 102 determines whether the verification information acquired by the acquisition unit 101 is used for verifying the authenticity of the assertion detail of the content based on the assertion detail extracted from the content. For example, as described in the second example embodiment to be described below, the selection unit 102 may perform the above determination using a machine-learned language model. The process of extracting the assertion detail of the content may be performed by the information processing apparatus 1 or may be performed by another apparatus.

### Advantages of Information Processing Apparatus 1

As described above, the information processing apparatus 1 has a configuration including the acquisition unit 101 that acquires verification information for verifying authenticity of an assertion detail of the content, and the selection unit 102 that determines whether the acquired verification information is used for verifying the authenticity of the assertion detail of the content based on the assertion detail extracted from the content. Therefore, according to the information processing apparatus 1, it is possible to obtain the advantage that it is possible to avoid a decrease in accuracy of determination of the authenticity of the assertion detail of the content. According to the information processing apparatus 1, it is also possible to make an appropriate decision based on a result of the appropriate authenticity determination of the assertion detail of the content.

### Selection Program

The above-described functions of the information processing apparatus 1 can also be implemented by a program. A selection program according to the present example embodiment causes a computer to function as: the acquisition unit 101 that acquires verification information for verifying authenticity of an assertion detail of content; and the selection unit 102 that determines whether the acquired verification information is used for verifying the authenticity of the assertion detail of the content based on the assertion detail extracted from the content. According to the selection program, it is possible to obtain the advantage that it is possible to avoid a decrease in accuracy of determination of authenticity of an assertion detail of content.

### Selection Method

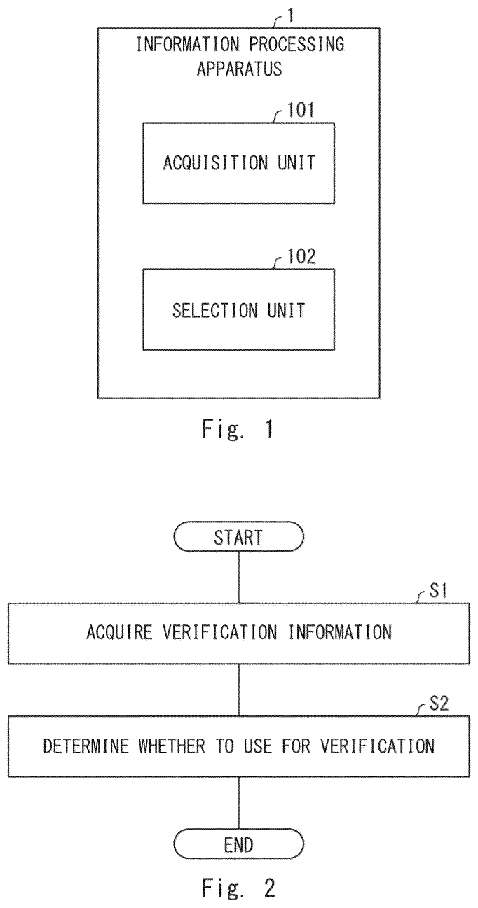

A flow of a selection method according to the present example embodiment will be described with reference to FIG. 2. FIG. 2 is a flowchart illustrating a flow of a selection method. An execution entity of each step in the selection method may be a processor included in the information processing apparatus 1, may be a processor included in another apparatus, or may be a processor in which the execution entities of steps are provided in different apparatuses.

In S1 (acquisition process), at least one processor acquires verification information for verifying authenticity of an assertion detail.

In S2 (selection process), at least one processor determines whether to use the verification information acquired in SI for verifying the authenticity of the assertion detail of the content based on the assertion detail extracted from the content.

### Advantage of Selection Method

As described above, the selection method according to the present example embodiment includes: an acquisition process of acquiring, by at least one processor, verification information for verifying authenticity of an assertion detail of content; and a selection process of determining whether the acquired verification information is used for verifying the authenticity of the assertion detail of the content based on the assertion detail extracted from the content. Therefore, according to the selection method of the present example embodiment, it is possible to obtain the advantage that it is possible to avoid a decrease in accuracy of determination of the authenticity of the assertion detail of the content.

### Second Example Embodiment

A second example embodiment that is an example embodiment of the present disclosure will be described in detail with reference to the drawings. Constituents having the same functions as the constituents described in the above-described example embodiment are denoted by the same reference numerals, and the description thereof will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in each of the drawings referred to for describing the present example embodiment can be adopted in the other example embodiments included in the present disclosure within a range in which no particular technical problem occurs.

### Configuration of Information Processing Apparatus 1A

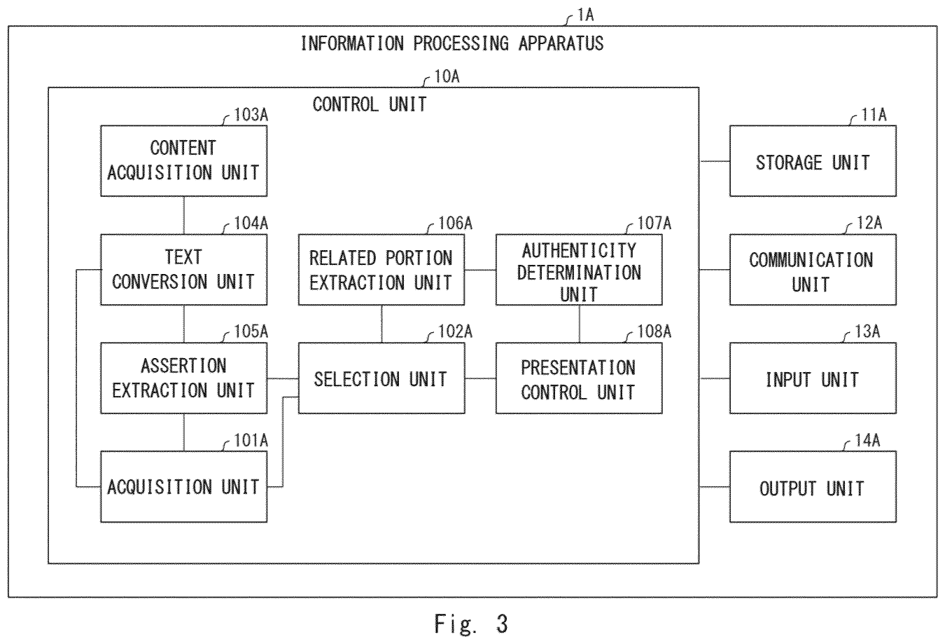

A configuration of an information processing apparatus 1A according to the present example embodiment will be described with reference to FIG. 3. FIG. 3 is a block diagram illustrating a configuration of the information processing apparatus 1A. The information processing apparatus 1A includes a control unit 10A that generally controls each unit of the information processing apparatus 1A and a storage unit 11A that stores various types of data used by the information processing apparatus 1A. The information processing apparatus 1A includes a communication unit 12A allowing the information processing apparatus 1A to communicate with another apparatus, an input unit 13A that receives an input to the information processing apparatus 1A, and an output unit 14A allowing the information processing apparatus 1A to output data. The control unit 10A includes a content acquisition unit 103A, a text conversion unit 104A, an assertion extraction unit 105A, an acquisition unit 101A, a selection unit 102A, a related portion extraction unit 106A, an authenticity determination unit 107A, and a presentation control unit 108A.

The content acquisition unit 103A acquires content that is an authenticity determination target of an assertion detail. Any content acquisition method is used. For example, the content acquisition unit 103A receives information for specifying content that is an authenticity determination target of the assertion detail from the user by the input unit 13A and acquires the content. Examples of the information for specifying content include uniform resource locator (URL) information indicating a specific page on the Internet, information specifying specific posting on a specific SNS, and information indicating a storage location of a specific content file including data of content. The content acquisition unit 103A may automatically acquire the content without manual intervention.

The target content may be any content as long as the content includes a certain assertion detail. For example, the target content may be a news article on the Internet, a message posted on an SNS or the like, audio/video data at the time of interrogation by the police, or the like. The target content may be limited to content in a specific field. For example, by limiting target content to articles in a medical field, authenticity of technical detail in the medical field can be verified. For example, by limiting the target content to documents related to healthcare, it is also possible to verify the authenticity of a detail related to healthcare.

The text conversion unit 104A converts a non-text element included in content acquired by the content acquisition unit 103A, that is, content that is an authenticity determination target of an assertion detail into text. Here, the “non-text element” indicates data with a format other than a text format, and examples of the non-text element include image data, moving image data, and audio data. The content may include a plurality of types of non-text elements. The content may include a plurality of specific type non-text elements. When it is not necessary to consider a non-text element or when content not including a non-text element is a target, the text conversion unit 104A may be omitted.

When image data is included in the content, examples of the information converted into text by the text conversion unit 104A include information for specifying a person included in an image, information indicating a state of the person, information for specifying an object, information indicating a state of the object, information indicating a place, and information indicating a time.

When audio data is included in the content, examples of the information converted into text by the text conversion unit 104A include a speech detail of a person, information regarding an environmental sound, and information regarding music included in audio. When moving image data is included in content, examples of the information converted into text by the text conversion unit 104A include various types of information relevant to the above-described image data regarding an image included in a moving image, and various types of information relevant to the above-described audio data regarding the audio included in the moving image.

Examples of a method of converting content of an image into text include bootstrap language image pre-training (BLIP). Examples of a method of converting a detail of a moving image into text include Video-LLaVa. Examples of a method of converting a detail of audio into text include Whisper. Examples of a method of extracting text in a moving image include an optical character recognition (OCR) technique such as vision transformer for fast and efficient scene text recognition (ViTSTR). For example, text may be generated from a non-text element using a vision language model or the like that receives a plurality of modalities as an input and generates text.

The text conversion unit 104A may analyze the non-text element from a certain viewpoint by artificial intelligence (AI) instead of the detail itself of the non-text element, and convert an analysis result into text. For example, the text conversion unit 104A may convert the result into text using AI that specifies a location based on a scenery included in an image or a moving image. The text conversion unit 104A may convert the determination result into text using AI that determines whether an image, a moving image, and audio are media generated by deep fake or media generated by the generated AI.

That is, the text conversion unit 104A may generate text information by at least one of the information in which a detail of a non-text element is converted into text and information in which a result of analyzing the non-text element from a certain viewpoint is converted into text.

The assertion extraction unit 105A extracts an assertion detail of content from the non-text element converted into the text by the text conversion unit 104A and the text element included in the content. The “assertion detail” is an opinion of which authenticity can be determined. In other words, the assertion detail is relevant to a concept, information, and the like that are assumed to be recognized by a recipient of content by receiving content.

Specifically, the assertion extraction unit 105A receives the text generated by the text conversion unit 104A with respect to one or more non-text elements included in the content and the text element included in the content as an input, generates a prompt indicating that the assertion detail is to be output, and inputs the prompt to a large language model (LLM). Here, depending on content, since it is also assumed that there are a plurality of assertion details, the assertion extraction unit 105A may generate a prompt that allows the plurality of assertion details to be output.

As the LLM, that is, a language model, for example, a model obtained using arrangement of constituent elements (words or the like) in a sentence or arrangement of a sentence and a sentence in sentences by machine learning may be applied. From the viewpoint of obtaining a highly accurate output, it is particularly preferable to use an LLM generated by machine learning using a large-scale language corpus. For example, a generative pre-trained transformer (GPT) that outputs a sentence including an input character string by predicting a character string having a high probability continued from the input character string can be used as the LLM used for extracting an assertion detail. In addition, for example, a text-to-text transfer transformer (T5), a bidirectional encoder Representations from transformers (BERT), a robustly optimized BERT approach (ROBERTa), an efficiently learning an encoder that classifies token replacements accurately (ELECTRA), or the like can be used as the LLM used for extracting the assertion detail.

The assertion extraction unit 105A may access an LLM service provided on a cloud via a communication network and use the LLM service, or may use an LLM processing unit constructed in the information processing apparatus 1. Then, the assertion extraction unit 105A extracts an output result from the LLM as an assertion detail.

Examples of the prompt include the following details. First, as a task, a subsequent prompt is input into the LLM.

“A text input formed from a combination of text, an image, audio, and a moving image is given. Your job is to comprehensively evaluate a given text input and accurately determine and extract an assertion included in the input. Here, the assertion is an opinion of which authenticity can be determined. Please extract all assertions if the assertions are included in a plurality of inputs.”

The above prompt includes at least one of text relevant to an image converted into text by the text conversion unit 104A, text relevant to a moving image, and text relevant to audio. Also, if the content includes a text element, the text element is also included in the prompt. When such a prompt is input to an LLM, the assertion detail of the content is output from the LLM.

As in the acquisition unit 101 according to the first example embodiment, the acquisition unit 101A acquires verification information for verifying authenticity of an assertion detail of content. Specifically, the acquisition unit 101A acquires verification information relevant to the assertion detail extracted by the assertion extraction unit 105A. The acquisition unit 101A may acquire the verification information using content of an extraction source of the assertion detail (content that is authenticity determination target), text generated from a non-text element included in the content, or the like.

The verification information may be information that can be used for determining authenticity, and a data format of the verification information is not particularly limited as in the first example embodiment. For example, the acquisition unit 101A may search for a web page using text indicating an assertion detail extracted by the assertion extraction unit 105A or a word or a sentence extracted from the text, and may acquire a predetermined number of top web pages among the detected web pages as the verification information. The acquisition unit 101A may acquire a part of the detected web page (for example, at least one of text, an image, audio, and a moving image included in the web page) as the verification information.

When an image is included in content that is an authenticity verification target, the acquisition unit 101A may acquire an image related to the image or an image similar to the image as the verification information by searching using the image. The same applies to a case where a non-text element other than an image is included in the content. Any searching target is searched for. For example, the acquisition unit 101A may perform searching for a predetermined database, a data lake, or the like.

The acquisition unit 101A may cause the LLM to generate a word or a search formula to be used for the searching. In this case, the acquisition unit 101A may perform the above searching using a word or a search formula generated by the LLM.

For example, the acquisition unit 101A may acquire the verification information input by a user of the information processing apparatus 1A via the communication unit 12A or the input unit 13A. The acquisition unit 101A may acquire, as the verification information, internal information such as data stored in advance in the storage unit 11A of the information processing apparatus 1A or data stored in a private network in which the information processing apparatus 1A is located.

When the internal information is used as the verification information, the acquisition unit 101A is not required to perform searching.

The acquisition unit 101A may search internal information to be used as verification information. As a searching method, a method similar to the case in which external information is used as the verification information can be applied.

The acquisition unit 101A may perform both the searching of the external information described above and the acquisition of the internal information described above. That is, the acquisition unit 101A may use both the information acquired through the searching and the information acquired without the searching as the verification information.

The non-text element included in the multimodal verification information acquired by the acquisition unit 101A as described above is converted into text by the text conversion unit 104A. Here, when the converted text is too long or redundant, a process or the like of inputting the text into the LLM and summarizing the text may be performed. When there are a plurality of text elements included in the verification information acquired by the acquisition unit 101A as described above, the text elements may be combined to form one piece of text. Similarly, when there are a plurality of pieces of text generated by the text conversion unit 104A, the pieces of text may be combined to form one piece of text. The text element included in the verification information and the text generated by the text conversion unit 104A may be combined to form one piece of text. In such cases, authenticity is determined using the integrated text. Any integration method is used. For example, the description of each piece of text may be integrated in a simple side-by-side manner, or may be integrated in such a manner that the LLM generates a summary of details of a plurality of pieces of text.

As in the selection unit 102 according to the first example embodiment, the selection unit 102A determines whether to use the acquired verification information for verifying the authenticity of the assertion detail of the content based on the assertion detail extracted from the content.

In a mode, the selection unit 102A may input the text indicating the assertion detail extracted from the content and the verification information to a machine-learned language model and generate an output indicating validity of using the verification information for authenticity verification. Then, the selection unit 102A may determine whether to use the verification information for authenticity verification based on the output, that is, a determination result of validity. In other words, for a set W=[w₁, . . . , w_{N}] of the verification information acquired by the acquisition unit 101A, the selection unit 102A may select verification information to be used for verification by solving a binary (relevant/non-relevant) classification problem with the LLM using the assertion detail of the content and wᵢ∈W as an input (where N is a natural number and i is a natural number equal to or less than N).

As will be described in detail below, the selection unit 102A may determine whether to use the verification information for verifying the authenticity of the assertion detail of the content in response to an input from the user. The selection unit 102A may determine whether to use the verification information for verifying the authenticity of the assertion detail of the content based on a detail of feedback from a viewer of the verification information regarding the verification information.

The related portion extraction unit 106A extracts a related portion related to the assertion detail of the content from the verification information determined to be used for authenticity verification by the selection unit 102A. Any method of extracting the related portion is used. For example, when the verification information is divided into a plurality of portions, the related portion extraction unit 106A may extract, as the related portion, a division including words that are the same as or similar to words included in the assertion detail of the content. For example, the related portion extraction unit 106A may input the verification information and text indicating the assertion detail extracted from the content to the machine-learned language model and extract the related portion. In other words, the related portion extraction unit 106A may extract a related portion eᵢ⊂Cᵢ related to the assertion detail in the LLM using the assertion detail and wᵢ∈W as an input (where i is a natural number).

The authenticity determination unit 107A determines the authenticity of the assertion detail extracted by the assertion extraction unit 105A. In the determination, the verification information acquired by the acquisition unit 101A or the related portion extracted from the verification information by the related portion extraction unit 106A is used. For example, the authenticity determination unit 107A generates a prompt representing that the text indicating the assertion detail extracted by at least the assertion extraction unit 105A and the related portion are input and an authenticity determination result of the assertion detail is output, and inputs the prompt to the LLM. The authenticity determination result may be indicated by a binary value of “true” or “false”, or may be indicated by evaluation results of a plurality of levels such as “true”, “slightly true”, “slightly false”, and “false”. As the authenticity determination result, the degree of likelihood of “true” may be indicated by a numerical value (0to 100 or the like).

The authenticity determination unit 107A may access an LLM service provided on a cloud via a communication network and use the LLM service, or may use an LLM processing unit constructed in the information processing apparatus 1. The authenticity determination unit 107A may divide text representing the assertion detail into a plurality of pieces, determine authenticity for each portion, and comprehensively determine the authenticity from each determination result.

Examples of the prompt include the following details. “An assertion detail obtained from the content and an evidence for determining the authenticity of the assertion detail are given. Your job is to determine whether the assertion detail is correct based on the evidence. Please select either “Fact” or “False” for the determination.”

The above prompt includes the text indicating the assertion detail extracted from the assertion extraction unit 105A and the text of the related portion extracted from the verification information acquired by the acquisition unit 101A. When the prompt is input to the LLM, the authenticity determination result of the assertion detail of the content is output from the LLM.

The text input to the LLM may include text that is a basis of the text in addition to the text indicating the assertion detail. For example, it is assumed that an image and first text are included in content that is an authenticity determination target. It is assumed that the text conversion unit 104A generates second text from the image. It is assumed that fourth text indicating the assertion detail of the content is generated from third text obtained by integrating the first text and the second text. In this case, the text input to the LLM during the authenticity determination may include at least one of the first text to the third text in addition to the fourth text.

The presentation control unit 108A presents various types of information to a user of the information processing apparatus 1. For example, the presentation control unit 108A presents a result of the authenticity determination of the content. In addition to the result of the authenticity determination of the content, the presentation control unit 108A may present a report including the basis of the determination and various types of information used for the authenticity determination. For example, when it is determined in response to an input from the user whether to use the verification information for verifying the authenticity of the assertion detail of the content, the presentation control unit 108A presents the verification information and a determination result of the validity of the verification information to the user. Any presentation mode and any presentation apparatus are used. For example, the presentation control unit 108A may display the determination result on a display device connected to the information processing apparatus 1A via the output unit 14A or may transmit data indicating the determination result to an information processing terminal used by the user via a communication network through the communication unit 12A.

As described above, the information processing apparatus 1A includes the acquisition unit 101A that acquires the verification information for verifying the authenticity of the assertion detail of the content, and the selection unit 102A that determines whether the acquired verification information is used for verifying the authenticity of the assertion detail of the content based on the assertion detail extracted from the content. Accordingly, it is possible to obtain the advantage that it is possible to avoid a decrease in accuracy of determination of the authenticity of the assertion detail of the content.

The selection unit 102A may input the text indicating the assertion detail extracted from the content that is an authenticity determination target and the verification information to the machine-learned language model, determine the validity of using the verification information for the authenticity verification, and determine whether to use the verification information for the authenticity verification based on the determination result of the validity. Accordingly, in addition to the advantages obtained by the information processing apparatus 1, it is possible to obtain the advantage of automatically determining whether the verification information is used for authenticity verification through simple processing.

The information processing apparatus 1A includes the related portion extraction unit 106A that extracts a related portion related to the assertion detail of the content from the verification information determined to be used for verifying the authenticity by the selection unit 102A and the authenticity determination unit 107A that determines the authenticity of the assertion detail of the content based on the related portion extracted by the related portion extraction unit 106A.

Therefore, according to the information processing apparatus 1A, in addition to the advantages obtained by the information processing apparatus 1, it is possible to obtain the advantage that an influence of a portion that is included in the verification information and is not related to the assertion detail of the content is eliminated and the accuracy of the authenticity determination is improved.

### Example of Authenticity Determination

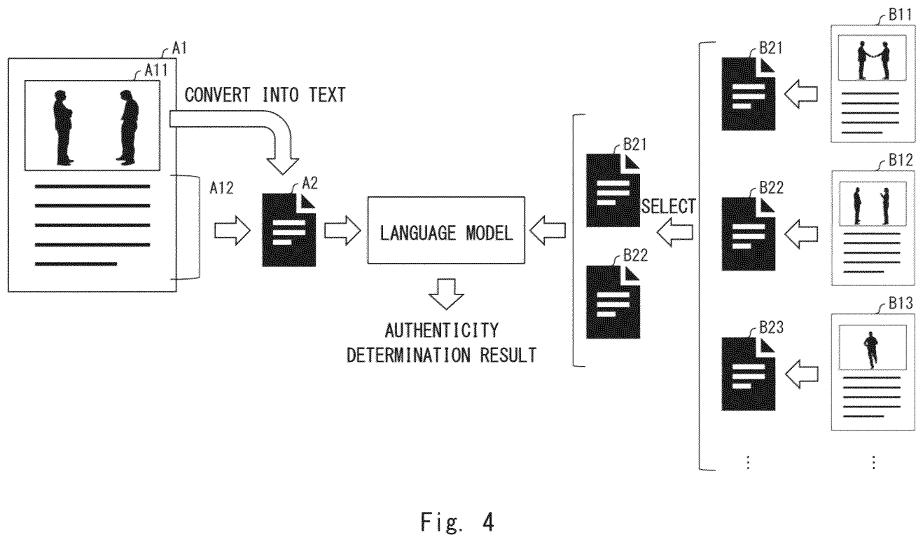

FIG. 4 is a diagram illustrating an authenticity determination example using an LLM (language model). In the example of FIG. 4, text generated by the text conversion unit 104A with respect to a non-text element A11 included in a content A1 and integrated text A2 in which text elements A12 included in the content are integrated are generated. The integrated text A2 indicates an assertion detail of the content A1.

Both the generation of the text from the non-text element A11 and the generation of the integrated text A2 can be performed using the LLM. The LLM used for the process may be the same as or different from the LLM used for authenticity determination. In particular, in the generation of text from the non-text element A11, it is preferable to use a generation model in accordance with the data format of the non-text element A11. The same applies to generation of text from a non-text element included in the verification information and integration of the generated text, which will be described below.

In the example of FIG. 4, a plurality of pieces of verification information are used to determine the authenticity of the assertion detail of the content A1. The verification information for determining the authenticity of the assertion detail of the content A1 includes pieces of verification information B11 to B13. Then, pieces of text B21 to B23 indicating details of the pieces of verification information B11 to B13 are generated from the pieces of verification information B11 to B13, respectively. Since the pieces of text B21 to B23 indicate the details of the pieces of verification information B11 to B13, respectively, the pieces of text B21 to B23 can also be said to be verification information. A method of generating the pieces of text B21 to B23 is similar to the method of generating the integrated text A2.

The selection unit 102A selects text to be used for determining the authenticity of the assertion detail of the content A1 from the pieces of text B21 to B23 generated in this way. In the example of FIG. 4, the pieces of text B21 and B22 are selected, and the text B23 is not selected. Therefore, the pieces of text B21 and B22 are used for authenticity determination, but the text B23 is not used for authenticity determination. Since the pieces of text B21 to B23 have one-to-one correspondence with the pieces of verification information B11 to B13, the selection of the pieces of text B21 to B23 is equivalent to the selection of the pieces of verification information B11 to B13.

In the verification, the authenticity determination unit 107A inputs the integrated text A2 and the pieces of text B21 and B22 generated as described above to the LLM. Accordingly, the authenticity determination result is output from the LLM.

As described above, it is not necessary to use one piece of whole verification information for verification, and the related portion extracted by the related portion extraction unit 106A may be used for verification. In this case, the related portion extraction unit 106A extracts a related portion related to the assertion detail of the content A1 from the pieces of texts B21 and B22. Then, the extracted related portion is input to the LLM.

### Selection Based on Detail of Feedback for Verification Information

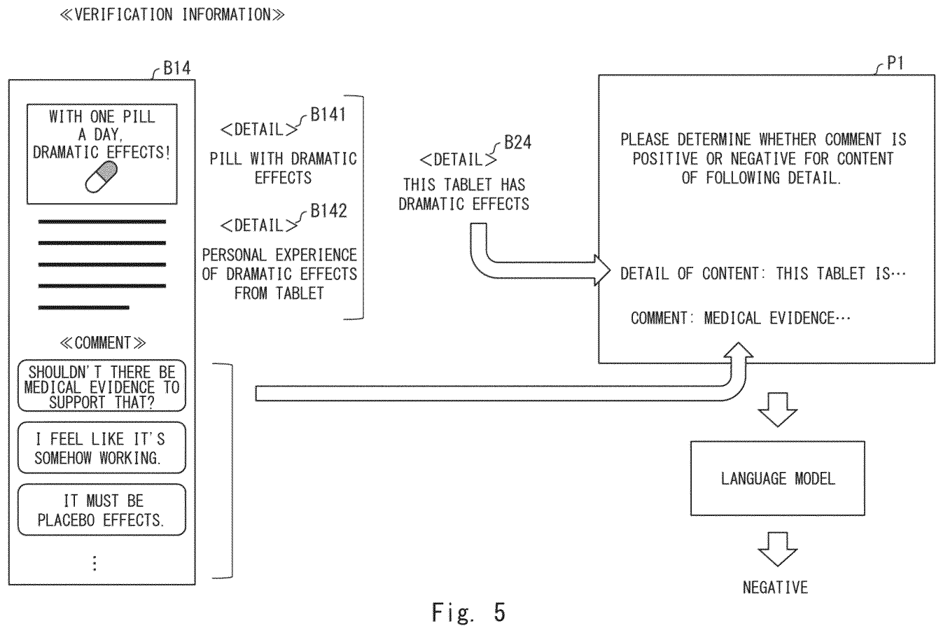

As described above, the selection unit 102A may determine whether to use the verification information for verifying the authenticity of the assertion detail of the content based on the detail of feedback from a viewer of the verification information regarding the verification information. This will be described with reference to FIG. 5. FIG. 5 is a diagram illustrating an example of selection based on a detail of feedback for verification information.

The verification information 14B illustrated in FIG. 5 includes an image and text. The verification information 14B is, for example, a web page. Then, in the example of FIG. 5, text B141 indicating the detail is generated from an image portion of the verification information B14, and text B142 indicating the detail is generated from the text portion. Then, from the pieces of text B141 and B142, text B24 indicating the whole detail of the verification information B14 is generated.

A comment from a viewer of the verification information 14B is attached to the verification information 14B. The comment indicates the detail of feedback from the viewer of the verification information 14B for the verification information 14B. The feedback from the viewer may be provided on a platform different from the verification information. For example, a comment posted on an SNS or the like regarding the verification information can be used as a comment indicating the detail of feedback from the viewer.

The selection unit 102A can determine whether the verification information 14B to which such feedback has been given is used for authenticity verification based on the detail of the feedback.

The selection unit 102A can also perform the determination using the LLM. For example, as in the example of FIG. 5, the selection unit 102A may input the text B24 and each comment for the verification information 14B to the LLM (language model) together with a prompt P1 for making an instruction to determine whether the detail of the comment is positive or negative. Accordingly, an output indicating whether the comment on the verification information 14B is negative or positive overall is obtained from the LLM. Therefore, the selection unit 102A can determine whether to use the verification information 14B for authenticity verification based on the output.

What type of information is to be output by the LLM and how to determine whether to use for authenticity verification according to the output of the LLM may be determined in advance. For example, as in the example of FIG. 5, when the LLM is caused to output two types of positive and negative answers, the answer may be used for authenticity verification if the answer is positive, and the answer may not be used for authenticity verification if the answer is negative. For example, the LLM may be caused to output a positive level of the detail of the feedback as a numerical value. If the numerical value is equal to or greater than a threshold, the numerical value may be used for authenticity verification. If the numerical value is less than the threshold, the numerical value may not be used for authenticity verification.

### Selection Method

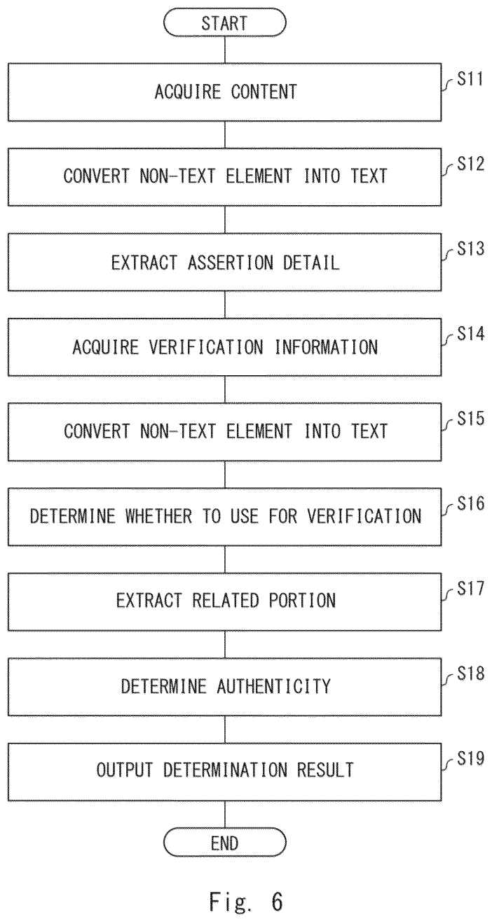

A flow of a process performed by the information processing apparatus 1A will be described with reference to FIG. 6. FIG. 6 is a flowchart illustrating an example of a process executed by the information processing apparatus 1A. In FIG. 6, processes of the selection method according to the present example embodiment are included.

In S11, the content acquisition unit 103A acquires content that is an authenticity determination target of the assertion detail. In S12, the text conversion unit 104A converts the non-text element included in the content acquired in S11 into text. When the content acquired in S11 includes a text element and a non-text element, the text conversion unit 104A may generate one piece of text by integrating the text element and the non-text element converted into text.

In S13, the assertion extraction unit 105A extracts the assertion detail from the non-text element converted into the text by the text conversion unit 104A in S12 and the text element included in the content acquired in S11. In this case, the assertion extraction unit 105A may set each of the assertion detail extracted from the non-text element converted into the text and the assertion detail extracted from the text element as the assertion detail of the content. The assertion extraction unit 105A may generate an assertion detail as the whole content from the assertion detail extracted from the non-text element converted into the text and the assertion detail extracted from the text element. The assertion detail that is the whole assertion detail can be generated by the LLM. When the text element and the non-text element converted into text are integrated to generate one text in S12, the assertion extraction unit 105A can extract the assertion detail of the content as the whole assertion detail from the one piece of text.

In S14, the acquisition unit 101A acquires the verification information that is the basis of the authenticity determination by the authenticity determination unit 107A. As described above, the acquisition unit 101A may acquire external information detected through the searching as the verification information, may acquire internal information input to the information processing apparatus 1A as the verification information, or may acquire both the external information and the internal information as the verification information. For example, when the verification information is acquired through the searching, the acquisition unit 101A performs the searching based on at least one of the text generated in S12, the text element included in the content acquired in S11, and the non-text element included in the content acquired in S11, and acquires the verification information.

In S15, the acquisition unit 101A converts the non-text element included in the verification information acquired in S14 into text. When one piece of verification information includes the text element and the non-text element, the text indicating an assertion detail as the whole assertion detail of the verification information may be generated from the non-text element and the text element converted into the text. This is similar to the case of extraction of the assertion detail of the content which is an authenticity determination target. When the non-text element is not included in the verification information acquired in S14, the process of S15 is omitted.

In S16, based on the assertion detail extracted from the content in S13, the selection unit 102A determines whether the verification information acquired in S14 is used for verifying the authenticity of the assertion detail of the content. For example, the selection unit 102A may input the text indicating the assertion detail extracted from the content and the verification information to the LLM and generate an output indicating the validity of using the verification information for authenticity verification. Then, the selection unit 102A may determine whether to use the verification information for authenticity verification based on the output, that is, a determination result of validity. When a plurality of pieces of verification information are acquired in S14, whether to use the verification information for authenticity verification is determined for each piece of verification information.

In S17, the related portion extraction unit 106A extracts a related portion related to the assertion detail of the content from the verification information determined to be used for authenticity verification in S16.

In S18, the authenticity determination unit 107A determines the authenticity of the assertion detail of the content based on the related portion extracted in S17. For example, the authenticity determination unit 107A generates a prompt indicating that the text indicating the assertion detail extracted by the assertion extraction unit 105A in S13 and the text indicating the related portion extracted by the related portion extraction unit 106A in S17 as inputs and the authenticity determination result of the assertion detail are output. When the prompt is input to the LLM, the authenticity determination result of the assertion detail of the content is output from the LLM.

In S19, the presentation control unit 108A presents the determination result of S18 to the user. When a plurality of pieces of text indicating the assertion detail are extracted in S13, the processes of S14 to S18 are repeatedly performed for each assertion detail. In this case, in S19, the authenticity determination result for each assertion detail may be presented. In this case, the authenticity may be comprehensively determined from each determination result.

### Another Example 1 of Selection

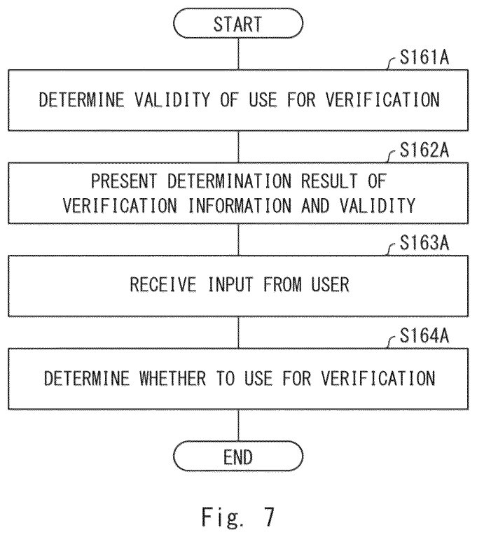

FIG. 7 is a flowchart illustrating another example of the process of S16 in FIG. 6. As described below, in the flow of FIG. 7, whether the verification information is used for verifying the authenticity of the assertion detail of the content is determined in response to an input from the user.

In S161A, the selection unit 102A determines validity of using the verification information for authenticity verification. For example, the selection unit 102A inputs the assertion detail extracted from the content and the verification information to the LLM, and causes the LLM to output a numerical value indicating how much the assertion detail and the verification information are related. In this case, the output numerical value is an index value indicating the validity of using the verification information for authenticity verification.

In S162A, the presentation control unit 108A presents a determination result of S161A to the user together with the relevant verification information. At this time, the presentation control unit 108A may also present the text generated from the non-text element of the verification information, the assertion detail extracted from the text, and the like to the user as determination materials for determining whether the verification information is adopted.

In S163A, for the verification information presented by the presentation control unit 108A, the selection unit 102A receives an input from the user who gives an instruction to use the verification information for verifying the authenticity of the assertion detail of the content. Any method of receiving an input from the user is used. For example, the selection unit 102A may receive the input from the user via the communication unit 12A, or may receive an input from the user via the input unit 13A.

In S164A, according to the input from the user received in S163A, the selection unit 102A determines whether the verification information presented in S162A is used for verifying the authenticity of the assertion detail of the content. Specifically, the selection unit 102A uses the verification information input by the user to the advantage of being used for verifying authenticity for verification of authenticity, and does not use the verification information input by the user not to the advantage of being used for verifying authenticity for verification of authenticity.

As described above, the information processing apparatus 1A includes the presentation control unit 108A that presents the verification information and the determination result of validity of the verification information to the user. Then, the selection unit 102A determines whether the verification information presented by the presentation control unit 108A is used for verifying the authenticity of the assertion detail of the content in response to the input from the user.

According to the above configuration, the user can determine whether to use the verification information for authenticity verification based on the determination result of the validity of the verification information by the information processing apparatus 1A. Then, a determination result of the user is reflected in the determination by the selection unit 102A. Accordingly, according to the above configuration, in addition to the advantage obtained by the information processing apparatus 1, it is possible to obtain the advantage that the determination of the user is reflected regarding whether to use the verification information for authenticity verification.

### Another Example 2 of Selection

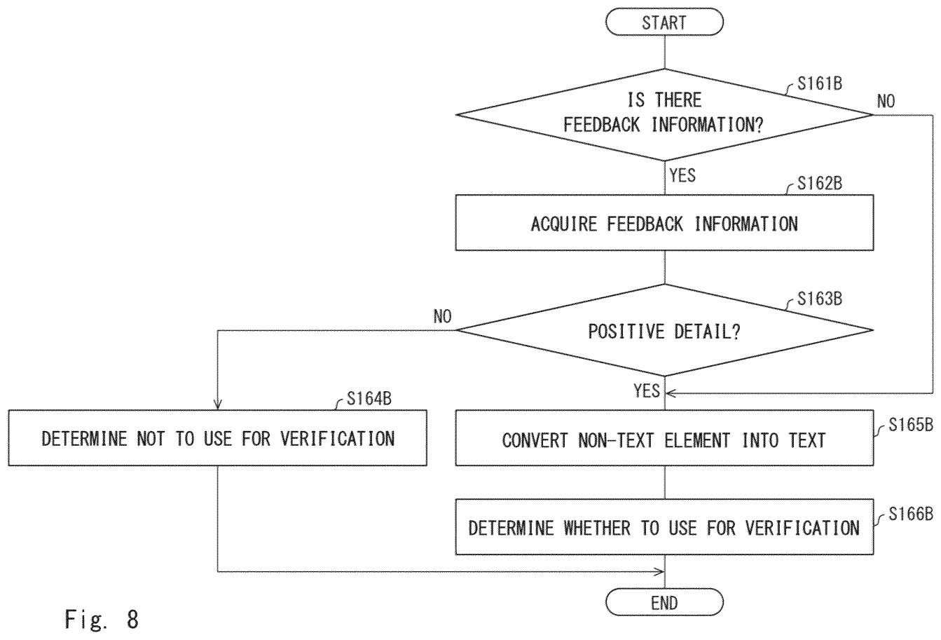

FIG. 8 is a flowchart illustrating still another example of the process of S16 in FIG. 6. As will be described below, in the flow of FIG. 8, whether to use the verification information for verifying the authenticity of the assertion detail of the content is determined based on the detail of feedback for the verification information.

In S161B, the selection unit 102A determines whether there is a feedback from the viewer of the verification information for the verification information. When the selection unit 102A determines that there is the feedback for the verification information (Yes in S161B), the process of S162B is subsequently performed. When it is determined that there is no feedback for the verification information (No in S161B), the process of S165B is subsequently performed.

In S162B, the selection unit 102A acquires feedback information indicating the detail of the feedback for the verification information. When there are a plurality of feedbacks, the selection unit 102A acquires feedback information for each feedback. The selection unit 102A may acquire the feedback information from a plurality of sources. For example, the selection unit 102A may acquire the feedback information from the same source as the verification information and may acquire the feedback information from other sources such as an SNS.

In S163B, the selection unit 102A determines whether the detail of the feedback information acquired in S162B is positive. For example, as in the example of FIG. 5, the selection unit 102A may determine whether the content is positive by comprehensively combining a plurality of comments acquired as the feedback information. For example, the selection unit 102A may determine whether each comment is a positive detail, and may determine that the content is a positive content overall when a predetermined number of comments or more or a predetermined ratio or more of comments with a positive detail are included. For example, when a feedback with highest evaluation from another viewer is a positive detail, the selection unit 102A may determine that the content is a positive detail overall. When Yes is determined in S163B, the process proceeds to S165B.

Conversely, when No is determined in S163B, the process proceeds to S164B. In S164B, the selection unit 102A determines not to use the verification information that is a determination target for verifying the authenticity of the assertion detail of the content.

In S165B, the text conversion unit 104A converts the non-text element included in the verification information into text. When the non-text element is not included in the verification information, the process of S165B is omitted. In S166B, the selection unit 102A determines whether the verification information is used for verifying the authenticity of the assertion detail of the content. In S166B, for example, a determination method similar to the method of S16 in FIG. 6 can be applied.

The processes of S165B and S166B may be performed before the processes of S161B to S163B. The processes of S165B and S166B may be performed in parallel with the processes of S161B to S163B. How much the detail of the feedback is positive may be calculated as a numerical value in S163B, and the validity of using the verification information for authenticity verification may also be calculated as a numerical value in S166B. In this case, the selection unit 102A may determine whether to use the verification information for authenticity verification based on whether a sum of the calculated numerical values is equal to or greater than a threshold.

The determination based on the input from the user illustrated in FIG. 7 may be incorporated in the process of FIG. 8. In this case, the verification information determined to be used for verification in S166B is presented to the user, and an input indicating whether the verification information is adopted is received.

As described above, the selection unit 102A may determine whether to use the verification information for verifying the authenticity of the assertion detail of the content based on the detail of feedback from the viewer of the verification information regarding the verification information. Accordingly, it is possible to obtain the advantage that it is possible to determine whether to use the verification information for verifying the authenticity of the assertion detail of the content in consideration of the detail of the feedback from the viewer of the verification information in addition to the advantages obtained by the information processing apparatus 1.

### Reference Example 1

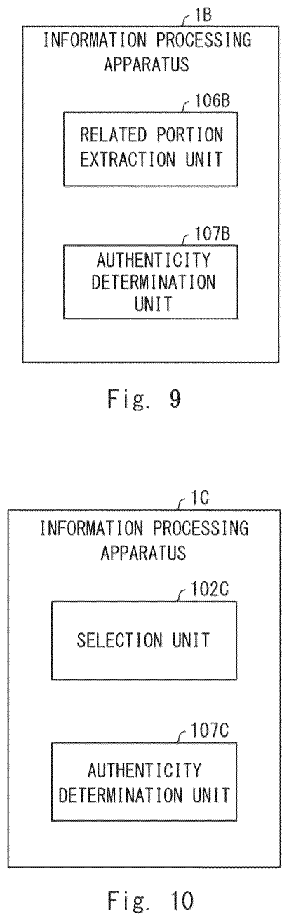

FIG. 9 is a block diagram illustrating a configuration of an information processing apparatus 1B according to the present reference example. As illustrated, the information processing apparatus 1B includes a related portion extraction unit 106B and an authenticity determination unit 107B.

As in the related portion extraction unit 106A according to the second example embodiment, the related portion extraction unit 106B extracts a related portion related to the assertion detail of the content from the verification information for verifying the authenticity of the assertion detail.

As in the authenticity determination unit 107A according to the second example embodiment, the authenticity determination unit 107B determines the authenticity of the assertion detail of the content based on the related portion extracted by the related portion extraction unit 106B.

As described above, the information processing apparatus 1B includes the related portion extraction unit 106B that extracts a related portion related to the assertion detail of the content from the verification information for verifying the authenticity of the assertion detail of the content, and the authenticity determination unit 107B that determines the authenticity of the assertion detail of the content based on the related portion extracted by the related portion extraction unit 106B. Accordingly, it is possible to obtain the advantage that it is possible to improve accuracy of the authenticity determination by eliminating an influence of a portion that is included in the verification information and is not related to the assertion detail of the content.

### Verification Program

The above-described functions of the information processing apparatus 1B can also be achieved by a program. A verification program according to the present example embodiment causes a computer to function as the related portion extraction unit 106B that extracts a related portion related to an assertion detail of content from verification information for verifying the authenticity of the assertion detail of the content, and the authenticity determination unit 107B that determines the authenticity of the assertion detail of the content based on the related portion extracted by the related portion extraction unit 106B. According to the verification program, it is possible to obtain the advantage that it is possible to improve accuracy of determination of authenticity by eliminating an influence of a portion not related to an assertion detail of content.

### Verification Method

A verification method according to the present reference example includes a related portion extraction process of extracting, by at least one processor, a related portion related to an assertion detail of content from verification information for verifying the authenticity of the assertion detail of the content, and an authenticity determination process of determining the authenticity of the assertion detail of the content based on the related portion extracted in the related portion extraction process. Therefore, according to the verification method according to the present example embodiment, it is possible to obtain the advantage that it is possible to improve the accuracy of the authenticity determination by eliminating an influence of a portion not related to the assertion detail of the content.

### Reference Example 2

FIG. 10 is a block diagram illustrating a configuration of an information processing apparatus 1C according to the present reference example. As illustrated, the information processing apparatus 1C includes a selection unit 102C and an authenticity determination unit 107C.

Based on a detail of feedback from a viewer of verification information for verifying authenticity of an assertion detail of content, the selection unit 102C determines whether to use the verification information for verifying the authenticity of the assertion detail of the content. The viewer, the feedback, and the method of determining whether to use the verification information for authenticity verification are as described in the second example embodiment, and thus description thereof will not be repeated here.

As in the authenticity determination unit 107A according to the second example embodiment, the authenticity determination unit 107C determines the authenticity of the assertion detail of the content using the verification information determined to be used for authenticity verification by the selection unit 102C.

As described above, the information processing apparatus 1C includes the selection unit 102C that determines whether to use the verification information for verifying the authenticity of the assertion detail of the content based on the detail of feedback from the viewer of the verification information for verifying the authenticity of the assertion detail of the content, and the authenticity determination unit 107C that determines the authenticity of the assertion detail of the content using the verification information determined to be used for the authenticity verification by the selection unit 102C. As a result, based on the detail of the feedback from the viewer of the verification information, it is possible to automatically determine whether to use the verification information for verifying the authenticity of the assertion detail of the content. Then, since the authenticity determination is performed using the verification information determined to be used for the authenticity verification, it is possible to obtain the advantage that it is possible to improve the accuracy of the authenticity determination.

### Verification Program

The function of the above-described information processing apparatus 1C can also be achieved by a program. A verification program according to the present example embodiment causes a computer to function as the selection unit 102C that determines whether to use verification information for verifying the authenticity of an assertion detail based on the detail of feedback from a viewer of the verification information for verifying the authenticity of the assertion detail of the content, and the authenticity determination unit 107C that determines the authenticity of the assertion detail of the content using the verification information determined to be used for the authenticity verification by the selection unit 102C. According to this verification program, it is possible to obtain the advantage that it is possible to improve the accuracy of the authenticity determination.

### Verification Method

A verification method according to the present reference example includes a selection process of determining, by at least one processor, whether to use verification information for verifying the authenticity of an assertion detail of content based on a detail of feedback from a viewer of the verification information for verifying the authenticity of the assertion detail of the content, and the authenticity determination process of determining the authenticity of the assertion detail of the content using the verification information determined to be used for an authenticity verification in the selection process. Therefore, in the verification method according to the present example embodiment, it is possible to obtain the advantage that it is possible to improve the accuracy of the authenticity determination.

### Modified Example

Any execution entity of each process described in the above-described example embodiment is used, and is not limited to the above-described example. For example, a system that has functions similar to those of the information processing apparatuses 1, 1A, 1B, and 1C can be constructed by a plurality of apparatuses capable of communicating with each other. The execution entity of each process illustrated in the flowcharts in FIGS. 6 to 8 may be one apparatus (also rephrased by a processor) or a plurality of apparatuses (also rephrased by processors).

### Example of Implementation by Software

Some or all of the functions of the information processing apparatuses 1, 1A, 1B, and 1C may be implemented by hardware such as an integrated circuit (IC chip) or may be implemented by software.

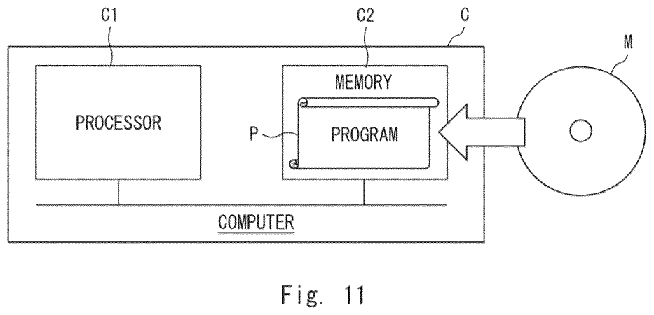

In the latter case, the information processing apparatuses 1, 1A, 1B, and 1C are implemented by, for example, a computer that executes a command of a program which is software for implementing each function. An example of such a computer (hereinafter, referred to as a computer C) is illustrated in FIG. 11. FIG. 11 is a block diagram illustrating a hardware configuration of the computer C that functions as the information processing apparatus 1, 1A, 1B, or 1C.

The computer C includes at least one processor C1 and at least one memory C2. A program P causing the computer C to operate as the information processing apparatus 1, 1A, 1B, or 1C is recorded in the memory C2. In the computer C, the processor C1 reads the program P from the memory C2 and executes the program P to implement each function of the information processing apparatus 1, 1A, 1B, or 1C.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for developing the program P during execution and temporarily storing various types of data. The computer C may further include a communication interface for transmitting and receiving data to and from another apparatus. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the information processing apparatuses 1, 1A, 1B, and 1C may be implemented by one processor provided in one computer, may be implemented in cooperation with a plurality of processors provided in one computer, or may be implemented in cooperation with a plurality of processors provided in a plurality of computers, respectively. The program causing the information processing apparatus 1, 1A, 1B, or 1C to implement each of the above functions may be stored in one memory provided in one computer, may be stored in a distributed manner in a plurality of memories provided in one computer, or may be stored in a distributed manner in a plurality of memories provided in a plurality of computers, respectively.

### Supplementary Notes

The present disclosure includes techniques described in the following supplementary notes. However, the present disclosure is not limited to the techniques described in the following supplementary note, and various modifications can be made within the scope described in the claims.

### Supplementary Note 1

An information processing apparatus including:
an acquisition means for acquiring verification information for verifying authenticity of an assertion detail of content; and
a selection means for determining whether the acquired verification information is used for verifying the authenticity of the assertion detail of the content based on the assertion detail extracted from the content.

### Supplementary Note 2

The information processing apparatus according to Supplementary Note 1, wherein the selection means inputs the verification information and text indicating the assertion detail extracted from the content to a machine-learned language model, determines validity of using the verification information for authenticity verification, and determines whether to use the verification information for the authenticity verification based on a determination result of the validity.

### Supplementary Note 3

The information processing apparatus according to Supplementary Note 2, further including a presentation control means for presenting the verification information and the determination result of the validity of the verification information to a user,
wherein the selection means determines whether to use the presented verification information for verifying the authenticity of the assertion detail of the content in response to an input from the user.

### Supplementary Note 4

The information processing apparatus according to any one of Supplementary Notes 1 to 3, further including:
a related portion extraction means for extracting a related portion related to the assertion detail of the content from the verification information determined to be used for the authenticity verification by the selection means; and
an authenticity determination means for determining the authenticity of the assertion detail of the content based on the related portion extracted by the related portion extraction means.

### Supplementary Note 5

The information processing apparatus according to any one of Supplementary Notes 1 to 4, wherein the selection means determines whether to use the verification information for verifying the authenticity of the assertion detail of the content based on a detail of feedback from a viewer of the verification information for the verification information.

### Supplementary Note 6

An information processing apparatus including:
a related portion extraction means for extracting a related portion related to an assertion detail of content from verification information for verifying authenticity of the assertion detail of the content; and
an authenticity determination means for determining the authenticity of the assertion detail of the content based on the related portion extracted by the related portion extraction means.

### Supplementary Note 7

An information processing apparatus including:
a selection means for determining whether to use verification information for verifying authenticity of an assertion detail of content based on a detail of feedback from a viewer of the verification information for verifying the authenticity of the assertion detail of the content; and
an authenticity determination means for determining the authenticity of the assertion detail of the content using the verification information determined to be used for authenticity verification by the selection means.

### Supplementary Note 8

A selection method causing at least one processor to execute:
an acquisition process of acquiring verification information for verifying authenticity of an assertion detail of content; and
a selection process of determining whether the acquired verification information is used for verifying authenticity of the assertion detail of the content based on the assertion detail extracted from the content.

### Supplementary Note 9

A selection program causing a computer to function as:
an acquisition means for acquiring verification information for verifying authenticity of an assertion detail of content; and
a selection means for determining whether the acquired verification information is used for verifying the authenticity of the assertion detail of the content based on the assertion detail extracted from the content.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

1. An information processing apparatus comprising:
at least one memory storing computer-executable instructions; and
at least one processor configured to access the at least one memory and execute the computer-executable instructions to:
(a) acquire verification information for verifying authenticity of an assertion detail of content; and
(b) determine whether the acquired verification information is used for verifying the authenticity of the assertion detail of the content based on the assertion detail extracted from the content.

2. The information processing apparatus according to claim 1, wherein
the at least one processor is further configured to
input the verification information and text indicating the assertion detail extracted from the content to a machine-learned language model,
determine validity of using the verification information for authenticity verification, and
determine whether to use the verification information for the authenticity verification based on a determination result of the validity.

3. The information processing apparatus according to claim 2, wherein
the at least one processor is further configured to
present the verification information and the determination result of the validity of the verification information to a user, and
determine whether to use the presented verification information for verifying the authenticity of the assertion detail of the content in response to an input from the user.

4. The information processing apparatus according to claim 1, wherein
the at least one processor is further configured to
extract a related portion related to the assertion detail of the content from the verification information determined to be used for the authenticity verification, and
determine the authenticity of the assertion detail of the content based on the extracted related portion.

5. The information processing apparatus according to claim 1, wherein
the at least one processor is further configured to
determine whether to use the verification information for verifying the authenticity of the assertion detail of the content based on a detail of feedback from a viewer of the verification information for the verification information.

6. A selection method, the selection method being performed by a computer executing instructions stored in a memory, the selection method comprising:
(a) acquiring verification information for verifying authenticity of an assertion detail of content; and
(b) determining whether the acquired verification information is used for verifying the authenticity of the assertion detail of the content based on the assertion detail extracted from the content.

7. A non-transitory computer-readable storage medium that stores a computer-executable program, the program comprising instructions for:
(a) acquiring verification information for verifying authenticity of an assertion detail of content; and
(b) determining whether the acquired verification information is used for verifying the authenticity of the assertion detail of the content based on the assertion detail extracted from the content.
